(19) United States
(12) Patent Application Publication
(10) Pub. No.: US 2003/0162621 A1
(43) Pub. Date: Aug. 28, 2003

(54) Hydromechanical automatic transmission for motorcycles and automobiles

(76) Inventors: Manuel Meitin, Las Palmas (ES); Douglas Manuel Meitin, Las Palmas (ES); Pedro Quinones, Miami, FL (US)

Correspondence Address: PEDRO QUINONES, 2800 SW 26 St., MIAMI, FL, 33133, US

(21) Appl. No.: 10/083,085

(22) Filed: Feb. 28, 2002

(51) Int. Cl. F16H 48/06

(52) U.S. Cl. 475/221

(57) ABSTRACT

An hydromechanical automatic transmission for automobiles/motorcycles having an internal combustion engine and driving wheels which includes a permanent connected complementary mechanical torque converter connected to an engine output for converting and transmitting into a mechanical way the torque from the engine to the driving wheels, especially at starting time or when rising slopes; a permanent connected complementary hydraulic torque converter for converting and transmitting in a hydraulic way the torque from the engine to the driving wheels, especially at normal cruising conditions.

Both converters complements each other, then both systems works together where no disconnection takes place at any time.

Hydraulic or electronic devices, as control means are no longer used.

No clutches of any type are never used.

### BACKGROUND OF THE INVENTION

1. Classification Definitions

This invention relates generally to hydromechanical transmissions for automobiles/motorcycles and more particularly to a hydromechanical automatic transmission combined with an internal combustion engine for vehicles.

2. Description of Prior Art

Any automatic transmission usually comprises a hydraulic torque converter operatively connected to an internal combustion engine for transmitting torque from the engine to the driving wheels. The torque generated by the engine is transmitted in various gear ratios to the driving wheels in cooperation with said hydraulic torque converter and a gear mechanism. However an automobile provided with a hydraulic transmission is said to be “less powerful”, especially at “starting time” or when rising a slope, if compared with a vehicle provided with a manual transmission.. This is understandable because the efficiency range of the engine is restricted when using a hydraulic torque converter. Vehicles provided with hydraulic torque converters has a longer “standing start” than one having a manual transmission because the oil toric flow inside the hydraulic torque converter requires an engine rotation rate over 900-1200 rpm in order to surpass the “stall point” for the turbine to be moved. The sliding at this point, between pump and turbine (at the hydraulic converter) is high, then an unavoidable increase in the liquid temperature is produced, for energy loses which instantly appears. When rising a slope, the resistance found at the driving wheels produces a similar effect.

It is also possible to use a more efficient hydraulic torque converter as to rise the “stall point”, however, fuel efficiency will be decreased due to non-matching of the engine and the hydraulic converter capacities.

According to the present invention, two permanent power paths: a mechanical and a hydraulic path complements each other. No gear reduction is provided between the engine output and the hydraulic converter input, then, no variation in the efficiency range of said hydraulic converter takes place, but it is possible to have the perfomance of a manual transmission, which is very useful especialy at starting time or when rising slopes complemented by the hydraulic performance at normal cruising speeds, for a variable and comfortable driving without disturbing steps, if it is taken into account that when the engine rotation is under 900-1200 rpm slipping is produced between the pump and turbine at the hydraulic converter because the oil toric flow is not yet strong enough for moving the turbine which is connected with the driving wheels, then the “stall point” is not still attainable , then a mechanical torque transmission is provided between the engine output and the mechanical torque converter input in such a way that the torque from the engine is converted and transmitted to the driving wheels in a mechanical way under the described rotation speed then an efficiency transmission effect is obtained.

When rising a slope, slipping inmediately appears if the torque is provided by any hydraulic means, because the higher transmission ratio permitted by an ordinary hydraulic converter is only as high as [2.1:1] but a higher transmission gear rate is demanded for overcoming the required torque needs. As a consecuence a mechanical torque transmission takes place in a similar way as at starting time. At normal cruising conditions, the transmission gear rate permited by the hydraulic torque converter becomes enough for transmittig the torque from the engine to the driving wheels without any mechanical mediator.

According with the present invention it is possible to complement the perfomance of a manual and hydraulic transmissions in a simple unit without any reduction device between the engine and the hydraulic torque converter for a more simpler mechanism, easier repairs, cheaper maintenance, and the lowest production cost for this kind of transmission having an improved fuel consumption due to the high efficiency rate obtained.

### BRIEF SUMMARY OF THE INVENTION

It is an object of the present invention to complement the perfomance of a manual transmission with the perfomance of a hydraulic transmission, joining in a single and compact unit their respective good qualities, taking apart their disadvantages, keeping a simple design, where no drivers assistance is required for shifting operations

It is therefore an object of the invention to provide an improved automatic transmission for automobiles/motorcycles.

It is another object of the invention to provide an improved automatic transmission for automobile/motorcycles by removing out any device intended for modifying the hydraulic torque converter's efficiency in such a way that a much better mechanical simplicity is still obtained and the production cost can be even lower.

It is object to improve fuel consumption.

It is also another object, to reduce, even more, the cost of repairs. The mechanism also becomes lighter in weight because less components are needed.

No complex devices, such as valve boxes, electronic devices as control means or multi-disc clutches are no longer used.

### BRIEF DESCRIPTION OF THE SEVERAL VIEWS OF THE DRAWING

Various other objects, features and attendant advantages of the present invention will be more fully appreciated as the same becomes better understood from the following detailed description when considered connection with the accompaying drawing in which reference characters designate like or corresponding parts through the several views and herein.

FIG. 1 Shows an embodiment suitable for automobiles in which a selector shifting device is included.

FIG. 2 Shows the shifting device used in motorcycles.

FIG. 3 Represents a graphic showing the transmission torque curves.

### DETAILED DESCRIPTION OF THE INVENTION.

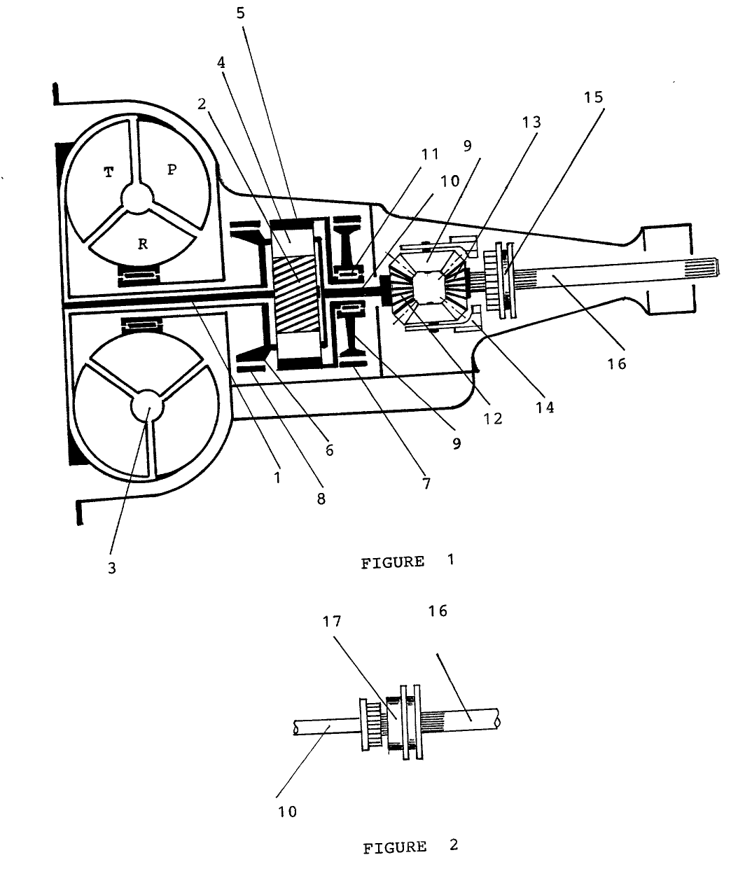

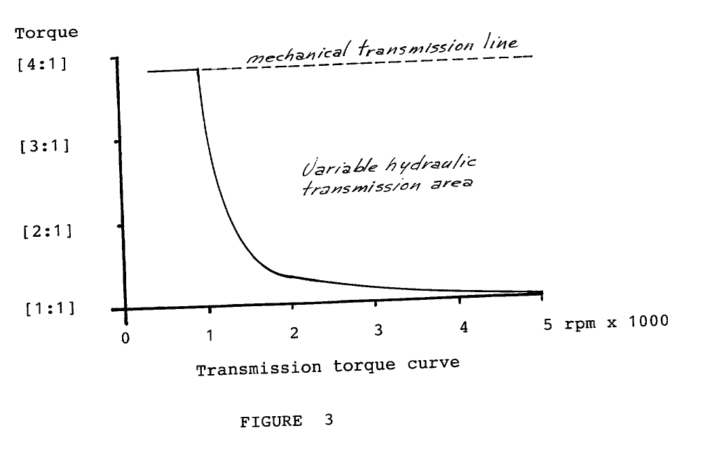

In accordance with the first embodiment as show in FIG. 1, the engine torque is transmitted at a time, to: the sun gear 2, by means of the shaft 1, and to hydraulic torque converter 3. At low engine rotation, two things may happen:

First: In FIG. 1, meanwhile the sun gear 2 is moving, if the ring gear 5 is stopped in one way by means of the free wheel 11 placed between the output shaft 10 and drum 9 on which a brake 7 or any braking device is applied, the satellites 4 start moving (translation movement) around the sun gear 2, transmitting and converting in a mechanical way the torque from the engine to the driving wheels.

Second: If the brake band 7 or any braking device is not applied on the drum 9, the ring gear 5 may rotate in a free and opposite way related to the engine rotation, then, no torque is mechanically transmitted to the driving wheels

At an engine rotation over 900-1200 rpm, the oil toric flow inside the hydraulic converter 3 becomes strong enough for moving the turbine T, then a torque is converted and may be transmitted to the driving wheels by hydraulic means in accordance with the degree of resistance found at said drivings wheels.

At starting time or when rising a slope the resistance found at the turbine T becomes to high for the hydraulic converter to move the vehicle by itself because the hydraulic transmission ratio is aproximatelly [2.1:1] when using an ordinary hydraulic converter, which is not addecuate for moving the vehicle under such conditions, but it said before that a mechanical torque of a higher transmission rates is available at the mechanical torque converter intended for such extreme conditions.

At normal driving conditions, the variable hydraulic torque is supplied by the hydraulic converter for moving the vehicle into the limits permitted by said hydraulic converter.

In order to complement the hydraulic torque, a free wheel 11 is placed between the ring gear 5 and the drum 9 in such a way that said ring gear 5 may rotate at different speeds assuming the various transmission rates supplied by the hydraulic converter.

If the mechanical torque converter gear rate is [3.6:1] and the hydraulic converter transmission ratio is [2.1:1] it means that when the hydraulic path predominates the ring gear 5 is not motionless but moving at certain speed in order to compensate such a transmission rate given by the hydraulic converter which is smaller than the relation provided by the mechanical converter.

At normal cruising conditions, the speed of the turbine T and the pump P tends to reach a similar value, then the ring gear 5 and the sun gear 4 must turn at a similar speed, almost as a unit, in order to adjust its transmission rate, then, without the action of the free wheel 11, it can not be done.

When a significant resistance appears at the driving wheels, the same resistance is found at hydraulic converter's turbine T, then the oil flow gets a curved direction when returning to the pump, and a torque increase takes place at the hydraulic converter.

If such a resistance becomes to high for the hydraulic converter to move the vehicle, sliding is produced between the pump P and the turbine T, then the ring gear 5 becomes motionless and the torque from the engine is mechanically transmitted by means of the mechanical torque converter to the driving wheel at the gear transmission rate given by said mechanical converter.

The transmission only requires one planetary gear system because the hydraulic converter is moved by the engine itself, and not by an intermediate planetary gear system used in other transmissions for the varying the efficiency range of the hydraulic torque converter without changing it's size. Hydraulic or electronic control devices and multi-discs clutches are not longer used.

As a result, the structure of the whole mechanism becomes the simplest, and the production cost the lowest for this kind of transmission.

According to the appliance, a reverse drive mechanism must be added.

When applying for motorcycles only a simple shifting device is required for a neutral position and for a drive position. It only requires a coupling 17 for shifting the shaft 16.

When supplying for automobiles a shifting device is required for providing a reverse, neutral and drive positions.

The motorcycles device comprises:

A sliding coupling (17)

a turbine brake drum (6) is also required for shifting purposes taken into account that in spite of the engine rotation which may be under 500 rpm and the sliding produced is almost total, however the oil preasure produced inside the hydraulic converter makes no posibility for mechanical shifting.

The shifting selector applied to automobile comprises:

a primary bevel gear (12) which transmitts torque from the shaft (10) to the satellites (9).

If the body (14) is locked, the bevel gear (13) turns in opposite direction related to the engine rotation, then the reverse position is shifted, but if the sliding coupling is shifted with the body (14), the drive position is connected, and if the sliding coupling (15) is unshifted with the body (14) which is unlocked, then a neutral position is obtained.

The sliding coupling and the bevel gear (13) are connected in a permament way to the output shaft (16).

What we claim as our invention is:

1. A hydromechanical automatic transmission for automobiles, and motorcycles having a source of moving force and driving wheels.
Comprising:
a) a permanent connnected complementary hydraulic means for hydraulically converting and transmitting torque from the source of moving force to the driving wheels.
b) a permanent connected complementary mechanical power converter device for mechanically converting and transmitting torque from the source of moving force to the driving wheels.
c) an optional shifting device as driving selector mean.

2. A hydromechanical automatic transmission for automobiles and motorcycles as set forth in claim (1), in which the complementary mechanical power converter device.
Comprises:
a) a single planetary gear set.
b) a free wheel associated to a planetary ring gear and to a drum.
c) a brake device associated to a drum.

3. A hydromechanical automatic transmission for automobiles and motorcycles as set forth in claim (1) in which the complementary hydraulic means also comprises:
a) a brake device for momentary partially stopping said hydraulic means, only for shifting purposes.

4. A hydromechanical automatic transmission for automobiles having a source of moving force and driving wheels in which a shifting device as a selector mean for automobiles comprise:
a) a planetary bevel gear set
b) striated planetary body
c) a sliding shifting coupling
d) a yoque associated to a sliding shifting coupling
e) a locking lever intended for shifting the reverse position

5. A hydromechanical automatic transmission for motorcycles having a source of moving force and driving wheels in which a shifting device as a coupling mean comprises:
a) a sliding shifting coupling
b) a yoque intended for shifting purposes
